(19) United States
(12) Patent Application Publication
(10) Pub. No.: US 2026/0070437 A1
(43) Pub. Date: Mar. 12, 2026

(54) WIRELESS POWER TRANSFER TRANSMITTER SYSTEM IN NEW OR EXISTING CONCRETE PAVEMENT AND CONSTRUCTION METHOD THEREOF

(71) Applicants: Heritage Environmental Technologies, LLC, Indianapolis, IN (US); Heritage Research Group, LLC, Indianapolis, IN (US); Magment GmbH, Munich (DE)

(72) Inventors: Gerald Anton Huber, Indianapolis, IN (US); Xishun ZHANG, Indianapolis, IN (US); Stephen Matthew Friess, Indianapolis, IN (US); Mauricio Esguerra, Munich (DE); Rafael M. Acevedo Daunas, Bethesda, MD (US)

(73) Assignees: Heritage Environmental Technologies, LLC, Indianapolis, IN (US); Heritage Research Group, LLC, Indianapolis, IN (US); Magment GmbH, Munich (DE)

(21) Appl. No.: 18/826,268

(22) Filed: Sep. 6, 2024

(51) Int. Cl. B60L 53/12; E01C 19/48; H02J 50/00; H02J 50/10

(52) U.S. Cl. CPC B60L 53/12; E01C 19/48; H02J 50/005; H02J 50/10

(57) ABSTRACT

Embodiments of the present disclosure relate to a wireless power transfer transmitter system, a construction method of the wireless power transfer transmitter system, and a concrete paving machine. The method includes: forming, by a concrete paving machine configured to move in a paving direction for constructing a drivable civil structure, a magnetizable concrete mixture in-place within the drivable civil structure. The wireless power transfer transmitter system includes the magnetizable concrete mixture and further comprises a pre-manufactured transmitter coil or a pre-manufactured transmitter coil assembly, the magnetizable concrete mixture comprises a binding material plus one hundred percent or less magnetic particles, the pre-manufactured transmitter coil assembly comprises a transmitter coil and a holder, and a part of the transmitter coil is installed in the holder, and 0 to 90 percent of the transmitter coil is embedded in the magnetizable concrete mixture.

### TECHNICAL FIELD

Embodiments of the present disclosure generally relate to wireless charging technologies, and more particularly, to a wireless power transfer transmitter system, a construction method of the wireless power transfer transmitter system, and a concrete paving machine.

### BACKGROUND

One version of an electric road includes a transmitter coil installed in a concrete road which creates a magnetic field for charging of vehicles equipped with a receiver that pass overhead on the road. Another version is for charging of vehicles equipped with a receiver that park on the road or parking lot. Energy or power is transferred wirelessly using the magnetic field created by the transmitter coil. A third version includes transmitter coils installed on a floor either in a linear or a matrix configuration.

### SUMMARY

Embodiments of the present disclosure provide a wireless power transfer transmitter system and a construction method of the wireless power transfer transmitter system in a concrete pavement.

According to an aspect, there is provided a construction method of a wireless power transfer transmitter system, including:
forming, by a concrete paving machine configured to move in a paving direction for constructing a drivable civil structure, a magnetizable concrete mixture in-place within the drivable civil structure;
wherein the wireless power transfer transmitter system includes the magnetizable concrete mixture and further includes a pre-manufactured transmitter coil or a pre-manufactured transmitter coil assembly, the magnetizable concrete mixture includes a binding material plus one hundred percent or less magnetic particles, the pre-manufactured transmitter coil assembly includes a transmitter coil and a holder, and a part of the transmitter coil is installed in the holder, and 0 to 90 percent of the transmitter coil is embedded in the magnetizable concrete mixture.

According to another aspect, there is provided a concrete paving machine configured to move in a paving direction for constructing a drivable civil structure, the concrete paving machine including:
a concrete spreader configured to form a magnetizable concrete mixture in-place within the drivable civil structure;
wherein the wireless power transfer transmitter system includes the magnetizable concrete mixture and further includes a pre-manufactured transmitter coil or a pre-manufactured transmitter coil assembly, the magnetizable concrete mixture includes a binding material plus one hundred percent or less magnetic particles, the pre-manufactured transmitter coil assembly includes a transmitter coil and a holder, and a part of the transmitter coil is installed in the holder, and 0 to 90 percent of the transmitter coil is embedded in the magnetizable concrete mixture.

According to a further aspect, there is provided a wireless power transfer transmitter system, including:
a magnetizable concrete mixture; and
a pre-manufactured transmitter coil or a pre-manufactured transmitter coil assembly;
wherein the wireless power transfer transmitter system includes the magnetizable concrete mixture and further includes a pre-manufactured transmitter coil or a pre-manufactured transmitter coil assembly, the magnetizable concrete mixture includes a binding material plus one hundred percent or less magnetic particles, the pre-manufactured transmitter coil assembly includes a transmitter coil and a holder, and a part of the transmitter coil is installed in the holder, and 0 to 90 percent of the transmitter coil is embedded in the magnetizable concrete mixture.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 is a flowchart of a construction method of a wireless power transfer transmitter system according to an embodiment of the present disclosure.

FIG. 2 is a schematic cross section of a concrete pavement containing an on-site constructed wireless power transfer transmitter system using a magnetizable concrete mixture in a finished concrete drivable civil structure using a one pass construction method of a concrete paving machine according to an embodiment of the present disclosure.

FIG. 3 is a schematic diagram of a feeder assembly for the magnetizable concrete mixture and transmission coil assemblies with a lateral connection well during construction of a concrete pavement using the one pass construction method according to an embodiment of the present disclosure.

FIG. 4 is a longitudinal cross section of the feeder assembly mounted on a concrete paving machine.

FIG. 5 is a forward view of the feeder assembly mounted on the concrete paving machine.

FIG. 6 is a cross section of the transmitter coil assembly and the feeder assembly taken along A-A in FIG. 3.

FIG. 7 is a schematic diagram of a feeder assembly for magnetizable concrete mixture and transmission coil assemblies with an onboard connection well during construction of a concrete pavement using one pass of a concrete paving machine according to an embodiment of the present disclosure.

FIG. 8 is a cross section of a feeder assembly showing an alternative holder with an onboard connection well and a drive mechanism for controlling the holder delivery.

FIG. 9 is a schematic diagram of an alternative feeder assembly for magnetizable concrete and transmission coil assemblies with lateral connection well during construction of a concrete pavement using one pass of a concrete paver according to an embodiment of the present disclosure.

FIG. 10 shows a schematic diagram of an alternative holder with a lateral connection well and a drive mechanism for controlling the holder delivery according to an embodiment of the present disclosure.

FIG. 11 shows a schematic diagram of a removable construction top for a lateral or onboard connection well according to an embodiment of the present disclosure.

FIG. 12 shows a schematic diagram of an adjustable sleeve for a lateral or onboard connection well.

FIG. 13 shows a top view of a transmitter coil assembly with a lateral connection well showing joint connectors, connection wells and sawcuts for power cables.

FIG. 14 shows a top view of a transmitter coil assembly with an onboard connection well showing joint connectors, connection wells and sawcuts for power cables.

FIG. 15 shows a cross section of a transmitter coil assembly and a feeder system showing a holder and a power connection well.

FIG. 16 shows details of power cable connection to a transmitter coil and sawcuts for power cable(s) for a lateral connection well.

FIG. 17 shows details of power cable connection to transmitter coil and sawcuts for power cable(s) for an onboard transmitter coil connection well.

FIG. 18 is a schematic diagram showing a layout of transmitter coils, power cables and power supply cabinet on a concrete pavement.

FIG. 19 is a flowchart of a construction method of a wireless power transfer transmitter system according to an embodiment of the present disclosure.

FIG. 20 shows a cross section of a concrete pavement containing an on-site constructed wireless power transfer transmitter system using a magnetizable concrete mixture in a finished concrete drivable civil structure using two passes of a concrete paver according to an embodiment of the present disclosure.

FIG. 21 is a schematic diagram showing the position of cans.

FIG. 22 is a schematic diagram showing a cross section of a concrete pavement containing a pre-manufactured modular wireless power transfer unit in a concrete finished drivable civil structure according to an embodiment of the present disclosure.

FIG. 23 shows a cross section of an existing concrete pavement rehabilitated with an unbonded concrete overlay containing a pre-assembled modular transmitter unit.

FIG. 24 shows a plan view of concrete pavement containing pre-assembled modular transmitter units after two strips of regular concrete have been cast on either side of the modular transmitter units.

FIG. 25 shows a layout of transmitter coils, power cables and power supply in a parking lot with concrete pavement.

FIG. 26 shows a layout of transmitter coils, power cables and power supply retrofitted in an existing parking lot with concrete pavement.

### DETAILED DESCRIPTION

Although specific configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to affect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Before introducing the technologies provided by embodiments of the present disclosure, some terminologies used herein are first described.

In-place construction refers to the manufacturing and installation of a magnetizable concrete mixture and a transmitter coil assembly on site. In other words, the magnetizable concrete mixture and the transmitter coil assembly are installed at a job site, rather than being installed in an environment away from or different from the job site. The in-place construction may also be called as on-site construction.

Off-site construction refers to manufacturing of a component in an environment away from or different from a job site, and then transporting the component to the job site for assembling with other component(s).

A transmitter coil assembly includes a transmitter coil attached to a holder that provides ease of handling and maintains geometric stability of the transmitter coil. The holder may remain in place in the finished pavement, or the holder may be removed after installation of the transmitter coil.

A transmitter coil is electrically conductive Litz wire or copper tubes arranged in a preferential geometry to produce a desired magnetic field.

Modular construction refers to installation in a roadway or floor of a modular transmitter assembly containing magnetizable concrete mixture, a transmitter coil assembly and regular concrete which may be enclosed in a container or not.

Regular concrete mixture refers to a concrete mixture which is commonly used for construction of concrete pavement and does not include the magnetizable concrete mixture. In the following description, the regular concrete mixture and a non-magnetizable concrete mixture are used interchangeably.

Static charging is a process of transferring electrical power to a vehicle battery while a vehicle is stationary.

Dynamic charging is a process of transferring electrical power either to a vehicle battery or to electric motors while a vehicle is moving or to both at the same time.

The following describes embodiments of the present disclosure.

In order to realize a transmitter coil installed on a road to achieve wireless charging, a magnetizable concrete mixture may be formed in the road. The magnetizable concrete mixture is a concrete mixture containing magnetic particles (e.g., ferrite particles) of different sizes to replace all or a portion of the natural aggregate particles typically used in a concrete mixture. The magnetizable concrete mixture may be formed off-site and installed to become an integral part of the road. Alternatively, the magnetizable concrete mixture may be manufactured in-place to become an integral part of the road. A pre-manufactured transmitter coil or a pre-manufactured transmitter coil assembly may be formed in the magnetizable concrete mixture. In this way, when an electrical current flows in the pre-manufactured transmitter coil or the pre-manufactured transmitter coil assembly, a magnetic field can be generated, and the magnetic field serves as a medium for energy transfer, by means of which a current is induced in a secondary coil (also called as a receiver coil) which may be arranged on underside of a vehicle. Accordingly, the vehicle can be charged.

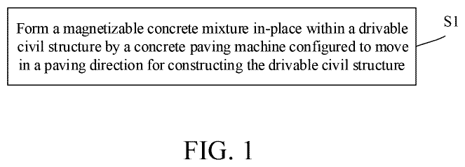

An embodiment of the present disclosure provides a construction method of a wireless power transfer transmitter system. As shown in FIG. 1, the method includes:

In S1, a magnetizable concrete mixture is formed in-place within a drivable civil structure by a concrete paving machine configured to move in a paving direction for constructing the drivable civil structure.

The wireless power transfer transmitter system includes the magnetizable concrete mixture and further includes a pre-manufactured transmitter coil or a pre-manufactured transmitter coil assembly. The magnetizable concrete mixture includes a binding material plus one hundred percent or less magnetic particles. The pre-manufactured transmitter coil assembly includes a transmitter coil and a holder, and a part of the transmitter coil is installed in the holder, and 0 to 90 percent of the transmitter coil is embedded in the magnetizable concrete mixture.

In the embodiment, when the concrete paving machine carries out in-place construction of the drivable civil structure, the concrete paving machine forms the magnetizable concrete mixture in-place within the drivable civil structure. Thus, on-site or in-place construction of the wireless power transfer transmitter system can be realized.

The magnetizable concrete mixture and the transmitter coil or coil assembly may be used for static charging to transfer electrical power to batteries of stationary vehicles or may be used for dynamic charging to transfer electrical power to batteries of moving vehicles, or to electric motors of moving vehicles.

The forming of the magnetizable concrete mixture may include forming the magnetizable concrete mixture and the pre-manufactured transmitter coil assembly simultaneously in-place within the drivable civil structure using a feeder assembly in the concrete paving machine. Alternatively, the magnetizable concrete mixture and the pre-manufactured transmitter coil assembly may be sequentially formed within the drivable civil structure.

The simultaneous forming/installation of the magnetizable concrete mixture and the pre-manufactured transmitter coil assembly may be called as a one pass construction method. The sequentially forming of the magnetizable concrete mixture and the pre-manufactured transmitter coil assembly or the pre-manufactured transmitter coil may be called as a two pass construction method.

The following first describes the one pass construction method in some example embodiments.

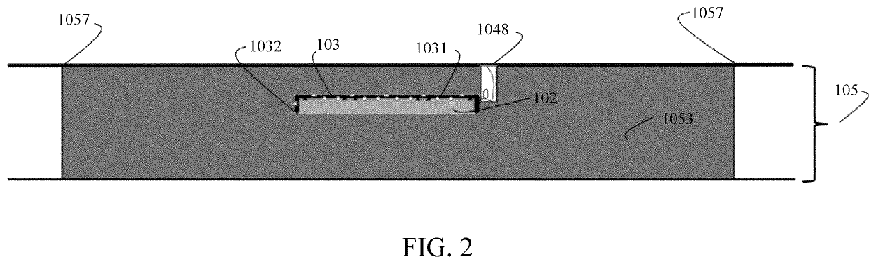

FIG. 2 is a schematic cross section of a concrete pavement containing an on-site constructed wireless power transfer transmitter system using a magnetizable concrete mixture in a finished concrete drivable civil structure using a one pass construction method of a concrete paving machine according to an embodiment of the present disclosure. FIG. 2 shows the location of a wireless power transfer transmitter system in a finished drivable civil structure constructed in one layer.

Referring to FIG. 2, a pre-manufactured transmitter coil assembly 103 is formed in a magnetizable concrete mixture 102. The pre-manufactured transmitter coil assembly 103 includes a transmitter coil 1031 and a holder 1032. A part of the transmitter coil 1031 is installed in the holder 1032, and another part of the transmitter coil 1031 is embedded in the magnetizable concrete mixture 102. That is, the transmitter coil 1031 is mounted in the holder 1032 with a desired exposure, typically between 0 to 90 percent of the diameter of the transmitter coil 1031. The top of the pre-manufactured transmitter coil assembly may be installed about 12 cm below the surface of the finished pavement 105.

The drivable civil structure may be a road or floor inside or outside a building, or other types of roads. For example, if the vehicle is a forklift or another vehicle that operates primarily indoors, such as a warehouse, the wireless power transfer transmitter system may be embedded in the floor or attached to the surface of the floor of the building. The drivable civil structure may be formed by regular concrete or fiber-modified concrete.

The magnetizable concrete mixture 102 includes a binding material (for example, a cement or another pozzolanic material based binding material) and magnetic particles. The magnetic particles in the magnetizable concrete mixture 102 may be ferrite particles. The magnetizable concrete mixture 102 may have a high-volume fraction of ferrite particles to provide power transfer to vehicles while parked or during motion. The volume fraction of the ferrite particles in the total mixture volume of the magnetizable concrete mixture 102 may be one hundred percent or less, for example the volume fraction may be not smaller than 35% and up to 90%. For example, the volume fraction may be 70% to 85%. Larger volume fraction results in a higher magnetic permeability. The higher the selected magnetic permeability, the more stray fields can be avoided and the lower the magnetic losses. Lower magnetic losses can make the slab thinner and less expensive as well as allowing a higher transmission efficiency. In other words, the magnetizable concrete mixture 102 can be considered as a magnetizable core containing ferrite particles bound together with cement or another pozzolanic material.

Ferrite is a manufactured ceramic material. The raw product may contain various sizes and shapes. For example, the largest pieces may be about 10 cm square. In general, ferrite pieces may be as large as 15 to 20 cm. The ferrite pieces may be reduced to smaller sizes using a crushing operation similar to the crushing of stone. The crushed ferrite pieces may be separated into individual sizes so proportions of each size may be recombined together to obtain a desired gradation. Alternat ively, ferrite particles may be manufactured in different sizes so a proportion of each size may be recombined together to obtain a desired gradation.

Mixing of the ferrite particles and binding material (or admixtures) can be accomplished by using a volumetric mixing truck. The volumetric mixing truck is a mobile mixing truck that is commonly used to manufacture concrete for bridge decks. Gates are set to volumetrically control the ratio between coarse and fine ferrite aggregate. As an example, this truck may blend two different sizes of prepared aggregate with the appropriate amount of cement, water and additives. An in-line blender mixes the components together.

The produced magnetizable concrete mixture includes ferrite particles and cement or another pozzolanic material. For example, the cement may be at least one of Portland cement, Portland cement with supplementary cementitious materials such as limestone, granulated blast furnace slag, fly ash or alternate binders composed of natural or synthetic crystalline materials.

The pre-manufactured transmitter coil assembly 103 may further include a connection well 1048. The connection well 1048 is attached to the holder 1032. Ends of the transmitter coil 1031 may be connected to power cable(s) in the connection well 1048 to realize electrical connection for the transmitter coil 1031.

The reference numeral 1057 indicates the edge of the concrete pavement lane. The pre-manufactured transmitter coil assembly 103 is surrounded by regular concrete mixture 1053.

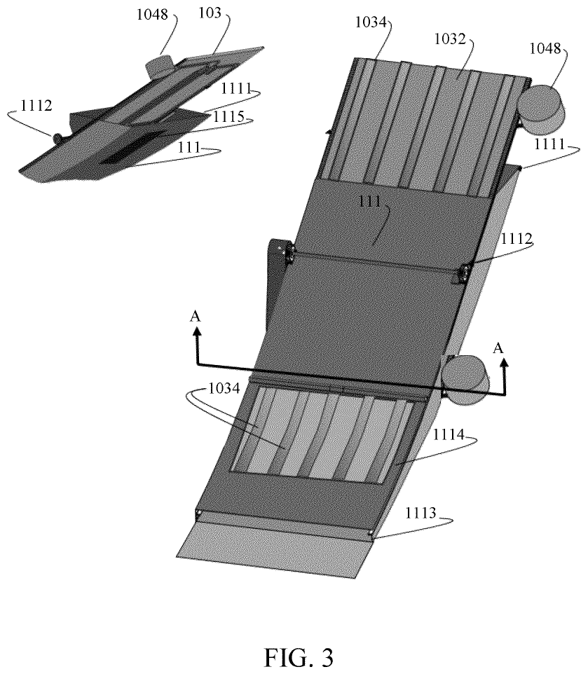

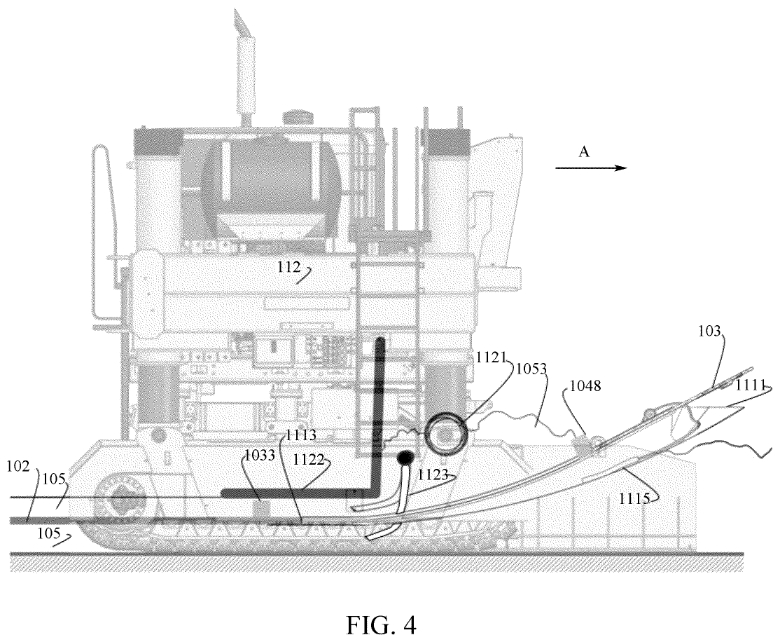

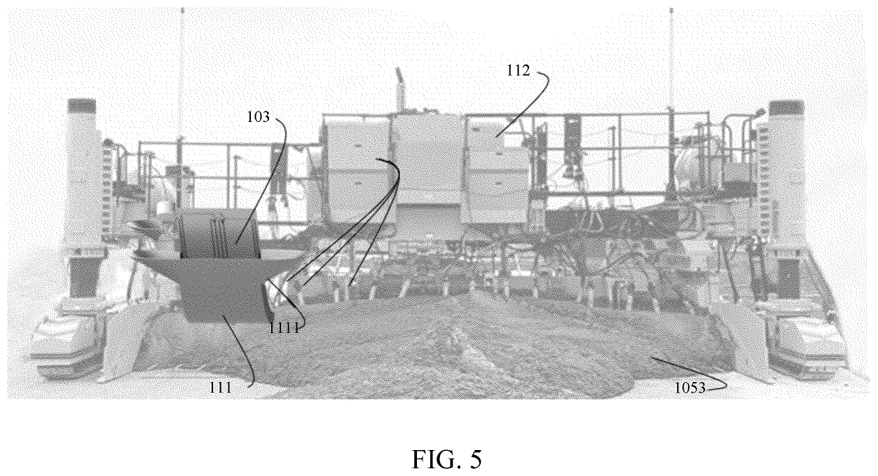

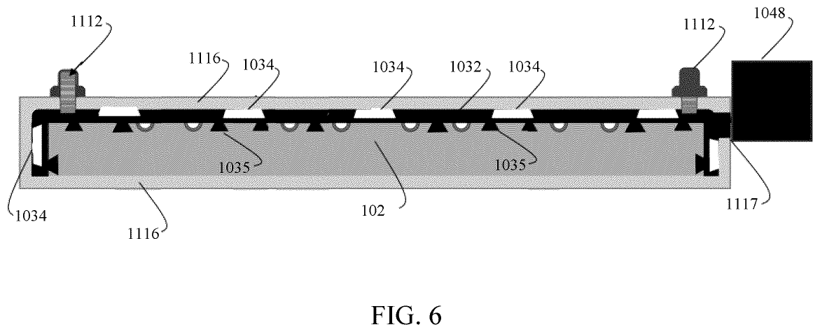

FIG. 3 is a schematic diagram of a feeder assembly for the magnetizable concrete mixture and transmission coil assemblies with a lateral connection well during construction of a concrete pavement using the one pass construction method according to an embodiment of the present disclosure. FIG. 4 is a longitudinal cross section of the feeder assembly mounted on a concrete paving machine. FIG. 5 is a forward view of the feeder assembly mounted on the concrete paving machine. FIG. 6 is a cross section of the transmitter coil assembly and the feeder assembly taken along A-A in FIG. 3, and FIG. 6 shows a transmitter coil holder with a lateral connection well and drive mechanism for controlling the holder delivery.

Referring to FIG. 3 to FIG. 6, the feeder assembly 111 includes a drive mechanism 1112 and a feeding hopper 1111. The drive mechanism 1112 is configured to positively feed and position the transmitter coil assemblies 103. The magnetizable concrete mixture is introduced from the top of the feeder assembly 111, i.e., from the feeding hopper 1111 which is on the underside of the holder. The feeding hopper 1111 is arranged on an underside of the drive mechanism 1112. The width of the feeder assembly 111 may be equal to the width of a transmitter coil assembly.

A vibrator 1115 on the underside of the feeding hopper 1111 ensures complete filling of the space below the transmitter coil assemblies 103.

An opening (a bonding window 1114) is located on the top of the feeder assembly to allow the regular concrete 1053 to contact the top of the holder (see FIG. 3). The top of the holder contains shear slots 1034 into which the regular concrete migrates. That is, the surface of the holder in contact with regular concrete has shear slots 1034 into which the regular concrete migrates and hardens. After hardening, the holder and the concrete are bonded to resist applied axial and shear forces. The location of the bonding window 1114 is preferentially placed where the regular concrete is being vibrated and can flow into the shear slots. The cross section of each shear slot 1034 may be a trapezoidal shape (as shown in FIG. 6). With this shape, the bottom edge of the cross section is wider than the top edge of the cross section, and the regular concrete can be bonded with the holder in a relatively large area at the bottom of the shear slot, thereby enhancing bonding effect.

A connection well 1048 may be attached laterally to the holder 1032. A slot 1117 on the side of the feeder assembly allows the lateral connection well 1048 to remain outside of the feeder assembly (see FIG. 6).

The feeder assembly 111 may be attached to the front of the concrete paving machine (for example, attached to a concrete spreader 112 in the concrete paving machine), as shown in FIG. 4 and FIG. 5. The magnetizable concrete mixture is placed in the feeding hopper 1111. The magnetizable concrete mixture may be placed into the feeding hopper 1111 using a transfer belt from a truck adjacent to the spreader or other such conveyance device. Common practice for concrete pavement construction is to place multiple lanes at the same time. If transmitter coil assemblies 103 are to be placed in more than one lane, multiple feeder assemblies 111 may be attached to the front of the spreader 112 at the appropriate/desired transverse offset to ensure a transmitter coil assembly 103 is located in the center of each lane.

The feeder assembly 111 is mounted on the concrete spreader in front of the pan 1122 of the concrete paving machine. The magnetizable concrete mixture is entered into the feeding hopper 1111 on the feeder assembly 111. In a normal concrete paving operation, vibrators are located transversely across the concrete spreader in front of the pan 1122 extending below the leading edge of the pan 1122. Near the feeder assembly, vibrators 1123 will extend under and above the feeder assembly to ensure normal consolidation of the regular concrete mixture around the feeder assembly. The concrete paving machine further includes a concrete auger 1121.

The end of the feeder assembly is an extrusion opening 1113 positioned at a desired depth such that the transmitter coil is located at the preferential depth below the surface of the pavement. The exit (the extrusion opening 1113) of the feeder assembly is preferentially located behind the front of the pan 1122 where the regular concrete mixture 1053 fills the shear slots on the side of the holder 1032. The bottom lip of the feeder assembly at the extrusion opening 1113 may be extended further behind the front of the pan 1122 where the regular concrete mixture 1053 is sufficiently consolidated as to not mix with the magnetizable concrete 102 but will bond to the magnetizable concrete beyond the edge of the lip. The extrusion opening 1113 may be a rectangular in cross section. The width of the extrusion opening 1113 may be equal to the width of the transmitter coil assembly. The height of the extrusion opening 1113 may be equal to the thickness of the magnetizable concrete mixture thickness plus the thickness of the holder and the transmitter coil.

That is, the feeder assembly is attached to a concrete spreader to extrude the magnetizable concrete mixture at the desired transverse offset and desired depth in which the location of the extrusion opening under the pan is preferentially located where the regular concrete is sufficiently consolidated to prevent mixing with the magnetizable concrete mixture and a lip on the bottom of the extrusion opening to prevent upward movement of regular concrete caused by presence of the feeder assembly.

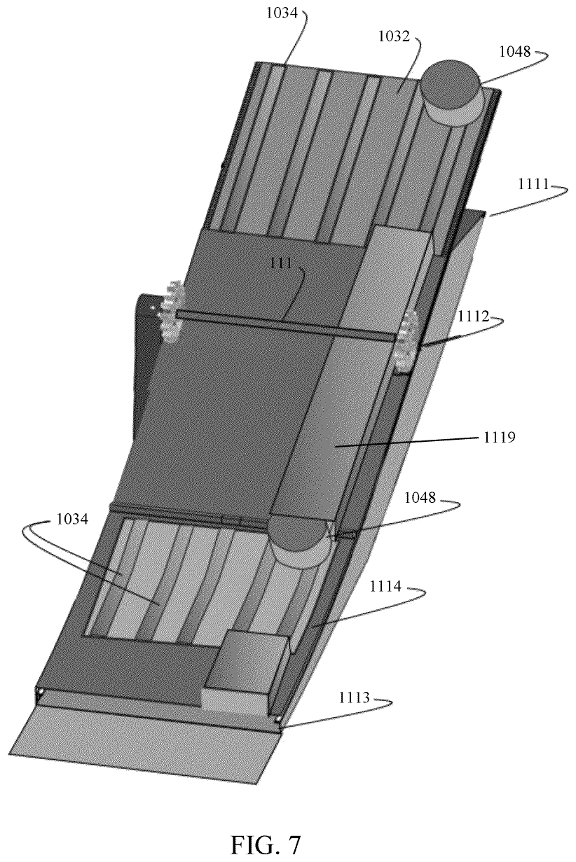

The holder 1032 may be made of polymer(s) that may include rubber, polyurethane, polypropylene, or another material. The holder 1032 may be made of a polymer in an inverted U shape. For example, as shown in FIG. 6, the holder 1032 is an inverted “U” shape against the top wall 1116 and two side walls of the feeder assembly. The height of the inverted “U” controls thickness of the magnetizable concrete and prevents mixing with regular concrete after the holder has exited the extrusion opening. The outside of the holder has continuous shear slots 1034 which are visible in FIG. 6 and FIG. 7. The inside of the holder has shear tabs 1035. That is, the surface of the holder in contact with magnetizable concrete mixture has shear tabs 1035 which protrude into the magnetizable concrete mixture around which the magnetizable concrete mixture hardens which ensures the holder does not debond from the magnetizable concrete mixture. As an example, the cross section of each shear tab 1035 may be a trapezoidal shape, with the wider side contacting the magnetizable concrete mixture and the narrower side contacting the bottom surface of the holder. As another example, the cross of each shear tab 1035 may be an inverted “T” shape.

The magnetizable concrete mixture is formed around the shear tabs. The shear slots on the outside of the holder and the shear tabs on the inside of the holder are designed to withstand shear stress within the concrete pavement and ensure that the holder remains securely bonded within the pavement structure. Debonding of the holder will cause cracking and premature failure of the adjacent concrete pavement leading to failure of the transmitter coil assembly.

It should be noted that the holder may be provided with: shear tabs 1035; or shear slots 1034; or, both the shear tabs 1035 and the shear slots 1034. That is, the holder does not necessarily include both the shear tabs 1035 and the shear slots 1034.

When the concrete paving machine moves in a paving direction (the direction as indicated by the arrow A in FIG. 4) for performing a concrete paving operation, the magnetizable concrete mixture is fed through the feeding hopper 1111 and the transmitter coil assemblies 103 are delivered by the drive mechanism 1112. The magnetizable concrete mixture and the transmitter coil assemblies 103 move together and are extruded simultaneously from the extrusion opening 1113 of the feeder assembly 111. Because the feeding hopper 1111 is arranged under the drive mechanism 1112, this can ensure that the extruded transmitter coil assemblies 103 are embedded in or on top of the magnetizable concrete mixture 102.

The drive mechanism 1112 ensures the transmitter coil assemblies 103 and the magnetizable concrete mixture flow consistently together through the feeder assembly 111. The feeder assembly 111 serves as an extruder for extruding the magnetizable concrete mixture and the transmitter coil assemblies 103 simultaneously. A feed rate for the drive mechanism 1112 to feed the transmitter coil assembly matches a forward speed of the concrete paving machine to ensure correct placement of the transmitter coil assemblies along the length of the road. For example, the feeder assembly 111 may simultaneously feed the transmitter coil assembly with a connection well (a lateral connection well or an onboard connection well) and the magnetizable concrete mixture into the concrete pavement at the same rate as the forward motion of the concrete spreader using a positive drive system. The feeder assembly may have a vibration mechanism (for example, the vibrator 1115 in FIG. 3) to ensure that voids are removed from the magnetizable concrete mixture.

In the construction method, while introducing the magnetizable concrete mixture into the feeding hopper and feeding the transmitter coil assembly through the drive mechanism, non-magnetizable concrete mixture (i.e., regular concrete mixture) is introduced through the bonding window on top of the feeder assembly 111 to fill shear slots 1034 on top of the holder 1032.

Referring to FIG. 3 and FIG. 4, during movement of the magnetizable concrete mixture and the transmitter coil assemblies 103, the regular concrete mixture 1053 is allowed to enter shear shots 1034 on the holder while the concrete mixture 1053 is sufficiently flowable. After hardening, the holder and the regular concrete mixture are bonded to resist applied axial and shear forces.

During feeding of the transmitter coil assemblies 103, the connection well 1048 is caused to move along a slot on a side of the feeder assembly to make the connection well remain outside of the feeder assembly. As shown in FIG. 3 and FIG. 6, a connection well 1048 is attached laterally to the holder 1032, and such connection well 1048 may be considered as a lateral connection well. A slot 1117 is arranged on a side of the feeder assembly 111. When the holder 1032 moves due to driving of the drive mechanism 1112, the connection well 1048 also moves along the slot 1117, and the connection well 1048 remain outside of the feeder assembly 111 during movement.

The attachment of the connection well to the holder is designed to resist pressure of the regular concrete mixture flowing around it and ensure that the connection well is correctly aligned. After the transmitter coil assemblies 103 and the magnetizable concrete mixture are extruded from the extrusion opening, the connection well 1048 is also installed in the concrete pavement. Ends of the transmitter coil can be connected with power cable(s) in the connection well 1048.

The height of the connection well 1048 is preferentially selected so the top of the connection well 1048 will be located sufficiently close to the surface of the concrete pavement 105. This will allow access into the connection well 1048 by removing the layer of concrete above the connection well 1048 and removing the top of the connection well enclosure.

According to an embodiment, conduit may be attached to the power wall connection. The conduit length is sufficient for the power cables to be connected to the transmitter coil. The outside end of the conduit has its own guide system to ensure that the conduit remains approximately perpendicular to the edge of the lane.

In the one pass construction method, during one pass of the concrete paving machine, both the transmitter coil assemblies 103 and the magnetizable concrete mixture as well as the connection well are formed simultaneously in-place in the concrete pavement, with the transmitter coil assemblies 103 being embedded in the magnetizable concrete mixture; meanwhile, regular concrete or fiber-modified concrete that surrounds the magnetizable concrete mixture and the transmitter coil assemblies 103 is also formed to form a road surface. The one pass construction method enables multiple components (for example, the transmitter coil assemblies and the magnetizable concrete mixture, regular concrete mixture below and above the transmitter coil transmitter, and the connection well) to be formed in-place in the concrete pavement in one operation, resulting in reduced costs and time required for construction.

Also, the connection well 1048 is formed to enable connection between ends of the transmitter coil and power cable(s).

Meanwhile, regular concrete mixture is formed around the transmitter coil assemblies 103 and the magnetizable concrete mixture, and regular concrete mixture can enter into the shear slots into which the regular concrete migrates and hardens and the surface of the holder in contact with magnetizable concrete has shear tabs which protrude into the magnetizable concrete around which the magnetizable concrete hardens which ensures the holder does not debond from the regular concrete or the magnetizable concrete.

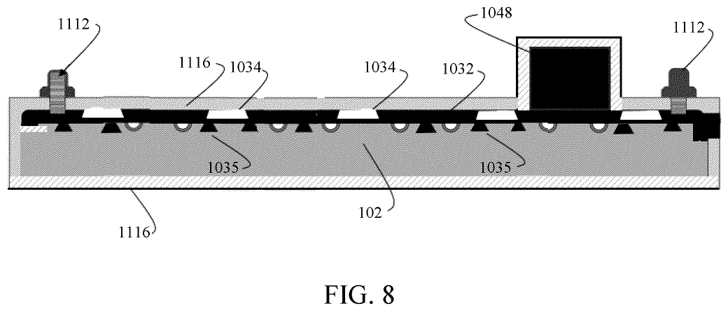

FIG. 7 is a schematic diagram of a feeder assembly for magnetizable concrete mixture and transmission coil assemblies with an onboard connection well during construction of a concrete pavement using one pass of a concrete paving machine according to an embodiment of the present disclosure. FIG. 8 is a cross section of a feeder assembly showing an alternative holder with an onboard connection well and drive mechanism for controlling the holder delivery.

The difference between the transmitter coil assemblies in FIGS. 7 and 8 and FIG. 3 in that: the connection well 1048 in FIG. 3 is attached laterally to an edge of the feeder assembly, and the connection well 1048 in FIGS. 7 and 8 is located onboard the holder 1032, i.e., the connection well 1048 is attached to the top of the holder 1032. The feeder assembly is shaped to allow passage of the connection well 1048 through the feeder assembly. For example, the feeder assembly has a protruding portion 1119 on top of the feeder assembly 111. During feeding of the transmitter coil assembly, the connection well 1048 is caused to pass through the protruding portion 1119.

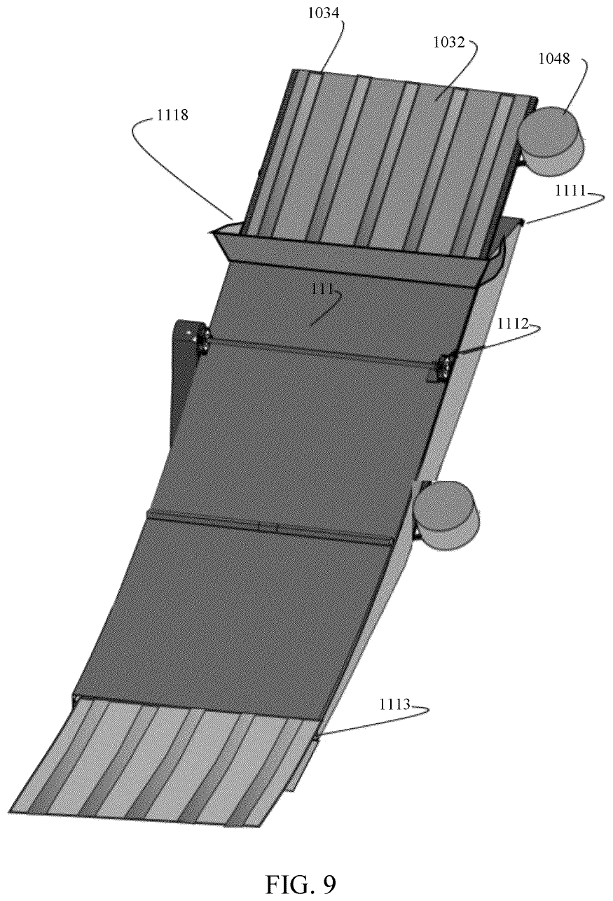

FIG. 9 is a schematic diagram of an alternative feeder assembly for magnetizable concrete and transmission coil assemblies with lateral connection well during construction of a concrete pavement using one pass of a concrete paver according to an embodiment of the present disclosure.

As shown in FIG. 9, a concrete grout fills the shear slots 1034 on the top of the holder to which regular concrete will bond after the holder has exited the extrusion opening. The grout may be a cement-based grout. The concrete grout is introduced into a grout hopper 1118 above the holder. The grout hopper 1118 is arranged at a magnetizable concrete mixture inlet of the feeding hopper 1111. The concrete grout is designed to fill the shear slots and at the same time have sufficient strength and cohesion so that when the holder exits the feeder assembly, it will bond with regular concrete above it. In this embodiment, the connection well may be attached laterally or may be on board the holder.

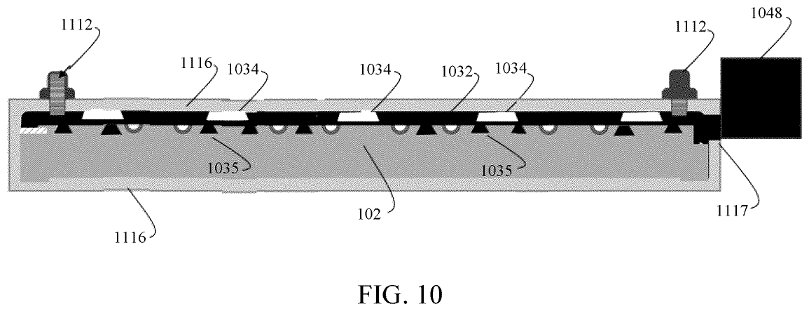

FIG. 10 shows a schematic diagram of an alternative holder with a lateral connection well and drive mechanism for controlling the holder delivery according to an embodiment of the present disclosure.

The difference between the holder in FIG. 10 and the holder in FIG. 6 is that: the holder 1032 in FIG. 10 is a flat plate with shear slots 1034 on the top and shear tabs 1035 on the bottom, and the holder 1032 in FIG. 6 is an inverted “U” shape against the top wall 1116 and two side walls of the feeder assembly 111.

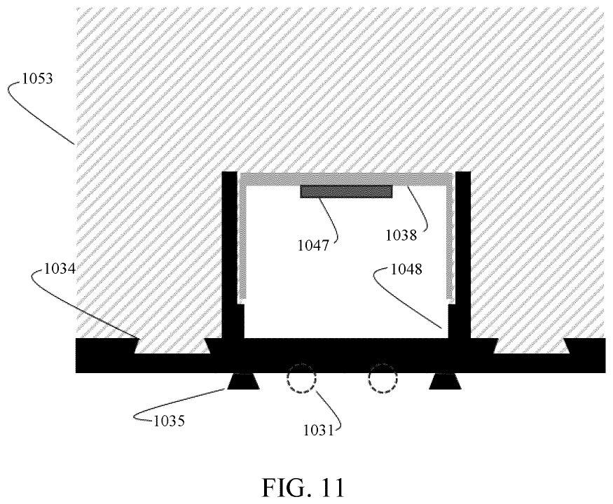

FIG. 11 shows a schematic diagram of a removable construction top for a lateral or onboard connection well according to an embodiment of the present disclosure. As shown in FIG. 11, the connection well 1048 has a removable construction top 1038. The removable construction top 1038 has a connection well location tab 1047 that can be used to locate the connection well within the freshly placed concrete. The removable construction top 1038 can be used with either a lateral or an onboard connection well.

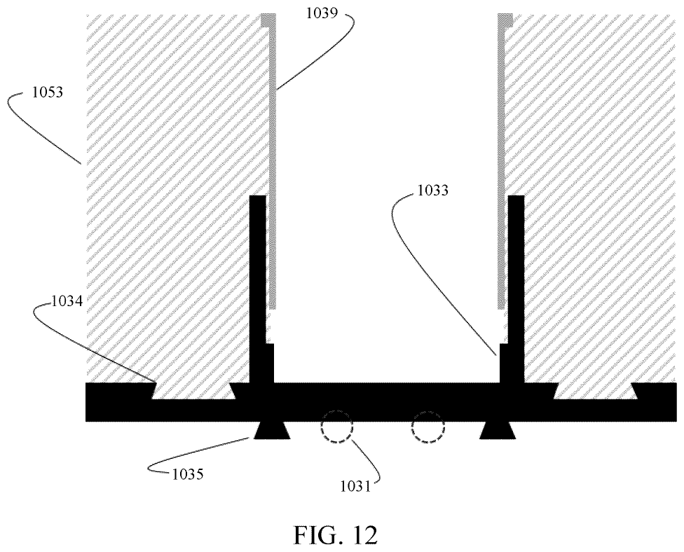

FIG. 12 shows a schematic diagram of an adjustable sleeve for a lateral or an onboard connection well. As shown in FIG. 12, the removable construction top 1038 can be removed and a connection well adjustable sleeve 1039 can be placed in the connection well 1048. Fresh concrete disturbed by removal of the construction cap can be replaced around the connection well adjustable sleeve. A connection well adjustable sleeve can be used with either a lateral or an onboard connection well. The removable construction top 1038 may be considered as a temporary top.

In the embodiments, the connection well has a removable construction top with an integral transmitter coil connection well location tab to allow accurate location of the connection well in the fresh concrete mixture, allow removal of fresh concrete above the connection well, allow replacement of the construction top with an connection well adjustable sleeve and installation of a non-magnetic connection well reinforcement ring to prevent crack initiation from the connection well.

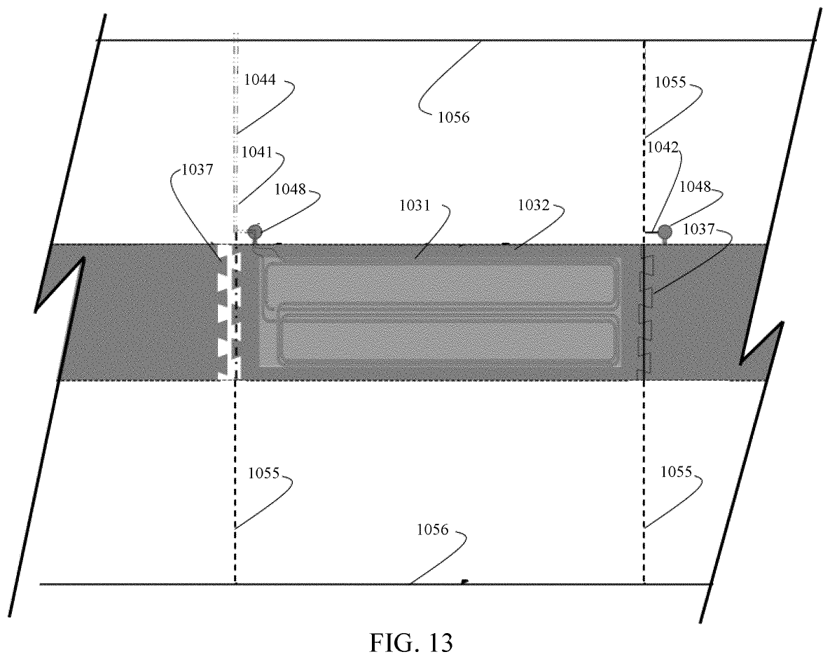

FIG. 13 shows a top view of a transmitter coil assembly with a lateral connection well showing joint connectors, connection wells and sawcuts for power cables. As shown in FIG. 13, the connection well 1048 is located a short distance from the sawn transverse joint in the pavement 1055 and is connected by a longitudinal sawcut 1042 for the power cable. The width and depth of the longitudinal sawcut is preferentially sized for the power cable(s) 1041. The longitudinal and transverse sawcuts for the power cable(s) 1044 and the concrete pavement transverse sawn joint 1055 are sealed using industry standard typical joint sealant 1045.

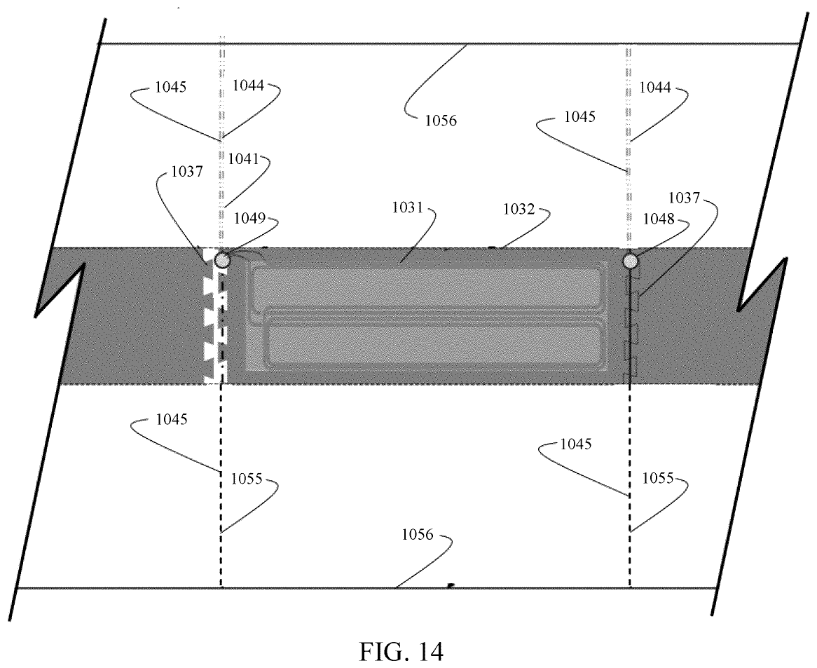

FIG. 14 shows a top view of a transmitter coil assembly with an onboard connection well showing joint connectors, connection wells and sawcuts for power cables. As shown in FIG. 14, the onboard connection well is preferentially located at the joint of two adjacent transmitter coil assemblies. A transverse sawcut with preferentially sized width and depth for a power cable(s) 1041 extends from the connection well to the edge of the pavement. The concrete pavement transverse sawn joint 1055 is coincident with the transverse sawcut 1044 for the power cable(s) 1041. The transverse sawcuts 1044 for the power cable(s) and the concrete pavement transverse sawn joint 1055 are sealed using sealant, e.g., industry standard typical joint sealant 1045.

Each holder has a length that is equivalent to required spacing of transverse joints required for concrete pavement in the drivable civil structure. Connection tabs 1037 are shown on the ends of the holder 1032 to provide positive connection between adjacent holders. The connection tabs are provided to maintain distance (accurate placement is critical to match location of sawn transverse joint). The connection tabs prevent gaps between adjacent holders. Preventing a gap allows placement of each transmitter coil within the space between transverse sawn joints 1055 in the concrete pavement. It also allows a series of transmitter coils to be correctly positioned in relation to the joints 1055 along the length of the road. The desired location for the concrete pavement transverse joint is above the connection tabs 1037. The thickness of each connection tab may typically be that of the coil holder. As another example, the thickness of each connection tab may also be full thickness of the magnetizable concrete mixture.

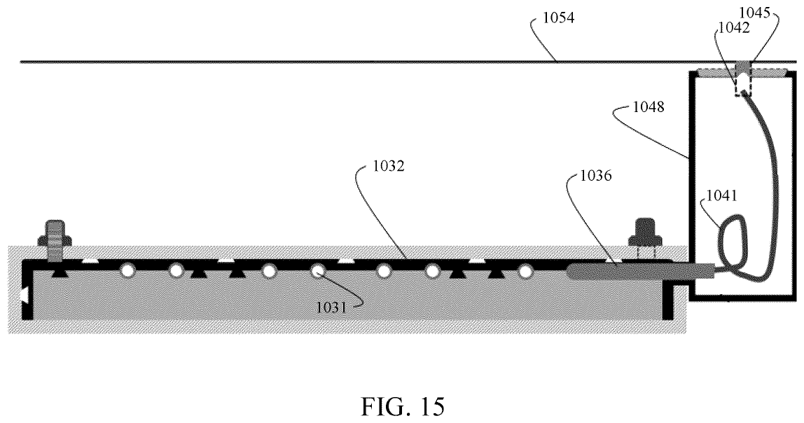

FIG. 15 shows a cross section of a transmitter coil assembly and a feeder system showing a holder and a power connection well. As shown in FIG. 15, the transmitter coil 1031 has a terminal 1036 that extends into the connection well 1048. The power cables 1041 inside the connection well 1048 are attached to the terminal(s) 1036 and continue into the longitudinal sawcut 1042 for the power cables for a lateral connection well or into the transverse sawcut for power cables 1041 for an onboard power connection well.

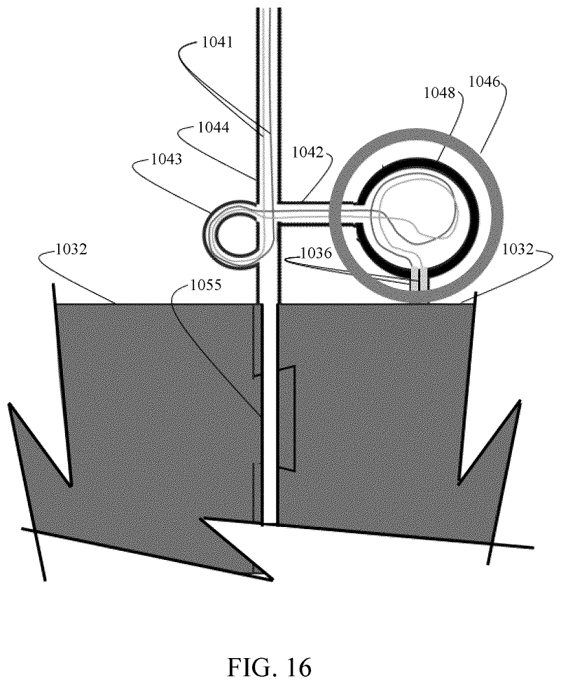

FIG. 16 shows detail of power cable connection to a transmitter coil and sawcuts for power cable(s) for a lateral connection well. As shown in FIG. 16, the power cables 1041 exit the lateral connection well into the longitudinal sawcut 1042 for power cable(s) and progress to a circular sawcut 1043 for power cable(s) direction change then enter the transverse sawcut 1044 for power cable(s) before progressing to the edge of the concrete pavement lane. A reinforcement ring 1046 constructed of non-magnetic material is preferentially located around the transmitter power connection well to prevent formation of a crack.

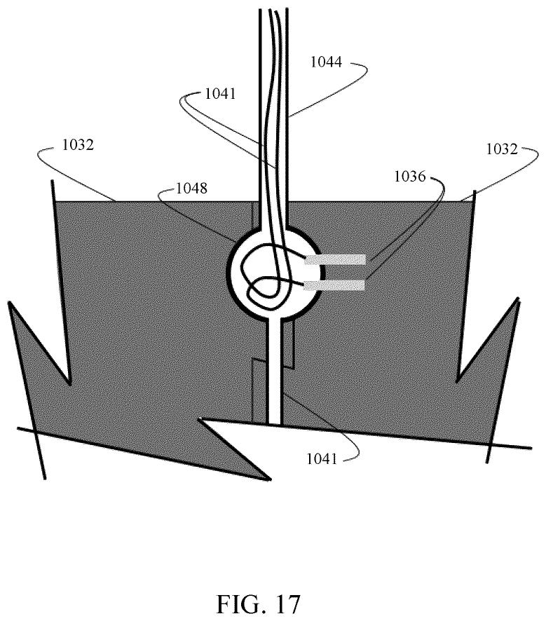

FIG. 17 shows details of power cable connection to a transmitter coil and sawcuts for power cable(s) for an onboard connection well. As shown in FIG. 17, the power cables 1041 exit the onboard transmitter power connection well into the transverse sawcut 1044 for power cable(s) before progressing to the edge of the concrete pavement lane.

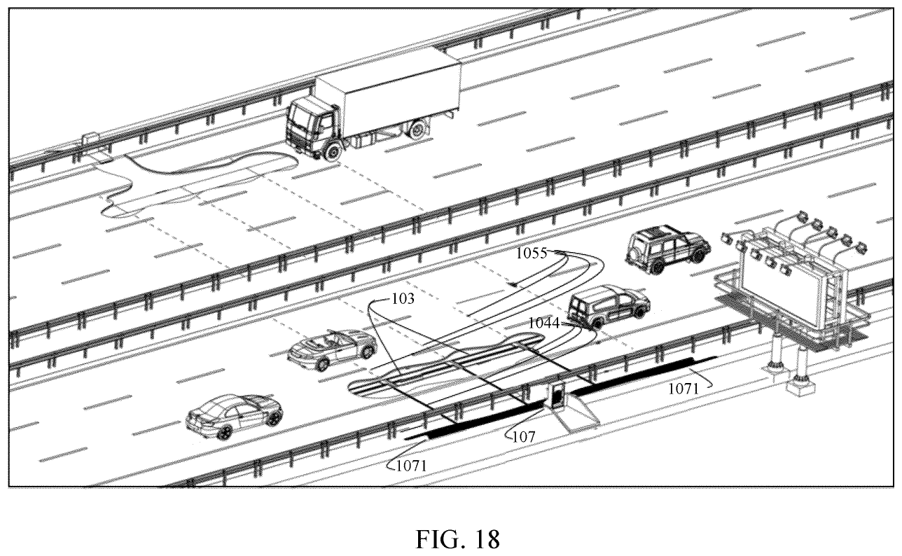

FIG. 18 is a schematic diagram showing a layout of transmitter coils, power cables and power supply cabinet on a concrete pavement. As shown in FIG. 18, the layout of the transmitter coil assemblies 103 is shown on the outside lane of a concrete highway as an example. The transverse sawcuts 1044 for power cable(s) commence at the transmitter coil assemblies and traverse across the lane and continue across the shoulder to the edge of the pavement. At the edge of the pavement the power cables are placed in a power cable channel 1071 along the edge of the road that brings the power cables to the power supply cabinet 107. If more than one lane has transmitter coil assemblies installed, the transverse sawcut for power cable(s) will commence at the furthest transmitter coil assembly, traverse across the adjacent lane(s) and the shoulder to reach the edge of the pavement and the power cable channel 1071. The transverse sawcut will be preferentially sized for the number of cables and size of cables that are used.

According to some embodiments of the present disclosure, the magnetizable concrete mixture and the transmitter coil or the transmitter coil assembly may be formed by the concrete paving machine using a two pass construction method.

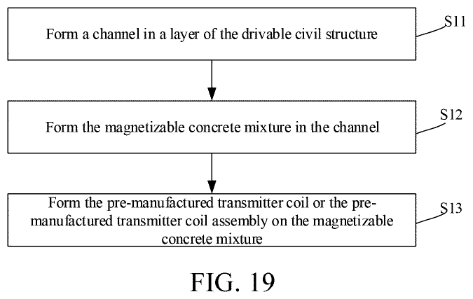

FIG. 19 is a flowchart of a construction method of a wireless power transfer transmitter system according to an embodiment of the present disclosure. The construction method in FIG. 19 is a two pass construction method. As shown in FIG. 19, the forming of the magnetizable concrete mixture includes:

In step S11, a channel is formed in a layer of the drivable civil structure.

As an example, the channel may be sprayed with a cohesion promoter.

In step S12, the magnetizable concrete mixture is formed in the channel.

In step S13, the pre-manufactured transmitter coil or the pre-manufactured transmitter coil assembly is formed on the magnetizable concrete mixture.

When performing construction of the upper layer, the bottom layer of the concrete and the transmitter coil assembly or the coil may be sprayed with a cohesion promoter. This can bond the upper layer of the concrete to the lower layer. A second layer of concrete may be placed on top of the first, this layer may use fiber-reinforced concrete. The layer may be green sawn to match sawcut joints in the lower layers.

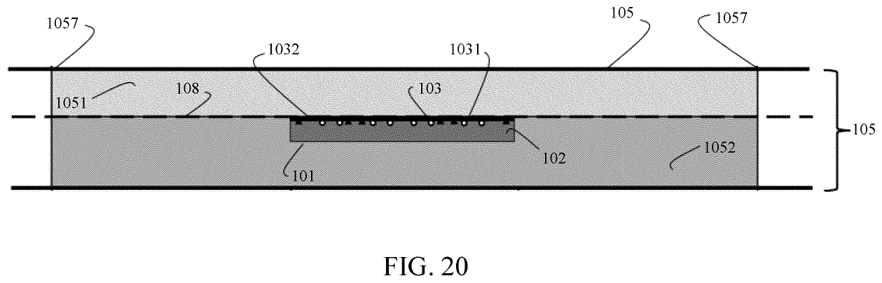

FIG. 20 shows a cross section of a concrete pavement containing an on-site constructed wireless power transfer transmitter system using a magnetizable concrete mixture in a finished concrete drivable civil structure using two passes of a concrete paver according to an embodiment of the present disclosure.

Referring to FIG. 20, the location of a wireless power transfer transmitter system is shown in a finished drivable civil structure constructed in two layers according to an embodiment of the present disclosure. The wireless power transfer transmitter system may include a channel 101, a magnetizable concrete mixture 102, and a transmitter coil assembly 103. The channel 101 is formed in the first layer 1052 of a drivable civil structure constructed with Portland cement concrete below the surface of the drivable civil structure. The first layer may contain fibers to prevent cracks from occurring or to ameliorate the effect of cracking. The magnetizable concrete mixture 102 is formed in the channel 101.

The concrete pavement in FIG. 20 may be constructed in two layers. The pre-manufactured transmitter coil assembly 103 is formed in the magnetizable concrete mixture 102. The pre-manufactured transmitter coil assembly 103 includes a transmitter coil 1031 and may also include a holder 1032. A part of the transmitter coil 1031 is installed in the holder 1032, and another part of the transmitter coil 1031 is embedded in the magnetizable concrete mixture 102. That is, the transmitter coil 1031 is mounted in the holder 1032 with a desired exposure, typically between 0 to 90 percent of the diameter of the Litz wire or copper tube in the transmitter coil 1031.

The top of the pre-manufactured transmitter coil assembly may be located about 12 cm below the surface of the finished pavement. A concrete pavement 105 may have for example a layer placed on top of the first layer 1052. Herein, the upper layer is referred to as a surface layer 1051. A bonding agent 108 may be applied to the top of the first layer 1052, the top of the magnetizable concrete mixture 102 if a holder 1032 is not present, and to the top of the holder 1032 if it is present. The surface layer 1051 may contain fibers to prevent cracking.

The surface layer 1051 covers the pre-manufactured transmitter coil assembly 103 or the transmitter coil as well as a concrete mixture 1052 of the drivable civil structure that surrounds the magnetizable concrete mixture 102. The surface layer may be composed of fiber-modified concrete or other such modified concrete mixture.

Regarding the two pass construction method, in a first pass, the concrete paving machine forms a channel in a layer. For example, a spreader on the concrete paving machine is fitted with a blocked out section equal to the thickness and width of the magnetizable concrete mixture (for example, 50 mm thick and 750 mm wide). The concrete paving machine may be a typical paving machine, and the feeder assembly as shown in FIGS. 3-5, 7 and 9 may not be needed. After the concrete paving machine moves in a paving direction in the first pass, because no concrete mixture is left at the position corresponding to the blocked out section and regular concrete mixture is poured on the road through other part of the spreader than the blocked out section, a channel is formed between two strips of regular concrete mixture. The first pass is to cast a partial thickness pavement that contains a channel where the transmitter coil assembly will be constructed. The thickness of the first pass may be 70 mm below the final surface elevation.

In a second pass of the concrete paving machine, the blocked out section is removed, and the magnetizable concrete mixture is formed in the channel using the spreader.

Then, the pre-manufactured transmitter coil or the pre-manufactured transmitter coil assembly may be formed on the magnetizable concrete mixture.

According to some embodiments, forming the pre-manufactured transmitter coil includes: placing a mold that has an engraving with a mirror image of the shape of the transmitter coil in the freshly formed magnetizable concrete mixture and a vibration mechanism (or called a vibrator), in such a way as to leave an imprint of the coil shape, removing the mechanism and the mold; and placing the pre-manufactured transmitter coil into the transmitter coil pattern left by the mold.

According to some other embodiments, forming the pre-manufactured transmitter coil or coil assembly includes: placing the pre-manufactured transmitter coil or coil assembly on freshly formed magnetizable concrete mixture; and vibrating the pre-manufactured transmitter coil assembly and the magnetizable concrete mixture using a vibrator.

In the above embodiments, only the pre-manufactured transmitter coil may be placed on the magnetizable concrete mixture. Alternatively, the pre-manufactured transmitter coil assembly may be formed on the magnetizable concrete mixture, and then the holder may be removed or not. If the coil holder is removed, the regular concrete, fiber-modified concrete mixture or asphalt mixture may be formed over the whole width of the lane.

The holder may have shear tabs on the surface in contact with the magnetizable concrete mixture to ensure that the holder does not debond from the magnetizable concrete mixture.

Optionally, the holder may also have shear slots on the surface in contact with the surface layer, for the regular concrete to migrate into.

In the two pass construction method, the concrete paving machine passes the paving site twice to form the channel and the magnetizable concrete mixture, respectively. The two pass construction method can realize in-place construction of the wireless power transfer transmitter system.

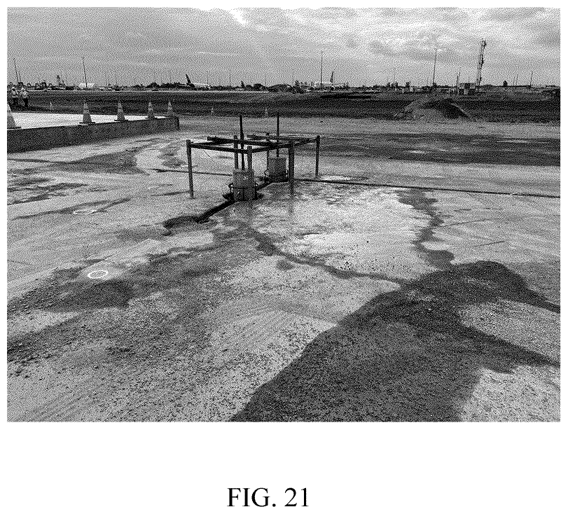

For the two pass construction method, the power cables may be placed into the top of the subgrade before placing the first lift of concrete. Can(s) can be installed into the subgrade, and the elevation may be set to match the thickness of the first lift. The holder may keep the can(s) at desired elevation. Power cables for each transmitter coil may be run into the inside of a can. The can may be grouted into place. The concrete paving machine may pass over the connection well. After installation of the magnetizable concrete mixture, the top of the can is opened to reveal the cables and make connections to the transmitter coils. After grouting the cables and the cans in place the holder may be removed. As shown in FIG. 21, the channels for power cables are visible, and the positions of cans are shown.

In some embodiments, the concrete pavement may be considered to be an existing concrete pavement that is rehabilitated by the addition of a concrete overlay, either bonded or unbounded. In some other embodiments, the concrete pavement may be considered to be a floor in a building formed by concrete and designed to carry vehicles or stationary equipment.

In the above construction methods, the wireless power transfer transmitter system is constructed in an unbonded or bonded concrete overlay constructed on an existing concrete pavement using the two pass construction method, or the one pass construction method.

In addition to the above discussed in-place construction methods, a concrete pavement may also be construed using a pre-assembled modular transmitter assembly. An embodiment provides a construction method of a wireless power transfer transmitter system using a pre-assembled modular transmitter assembly. The method includes: installation of a modular transmitter assembly. The modular transmitter assembly includes: a magnetizable concrete layer with an embedded transmitter coil, and regular concrete or fiber modified concrete below and/or above the magnetizable concrete-coil assembly forming a precast slab, and tie bars at sides of the modular transmitter assembly that extend in to the regular concrete and protrude from the modular transmitter assembly to bond with concrete that will be cast adjacent to the modular transmitter assembly.

The modular transmitter assembly may be considered as a module, and the module may be in a container or may be formed in a container that is removed before installation. The module is placed on the base layer and the top of the module becomes either the base for the surface mixture of the road or the surface of the road or the surface of a floor. The modular transmitter assembly would be placed in the appropriate place, in the center of a road lane, parking space or floor. Regular concrete material would then be placed on either side or surround the prefabricated module up to the same level of the modular transmitter assembly. This can therefore become the final road or floor surface or in a particular case, a layer of regular concrete, fiber-modified concrete or asphalt is placed over all the slabs to make the surface layer.

According to an embodiment, the modular transmitter assembly may be installed in an existing pavement structure or floor. The installation includes: forming a rectangular channel within the road, parking space or floor by saw cutting, milling, or another method, placing the modular transmitter assembly (i.e., the prefabricated magnetizable concrete slab) in the open space and filling the surrounding void with regular concrete so as to completely surround the assembly; the assembly can become the surface layer or for a particular case. In another case a final layer of concrete material or asphalt is placed over the whole surface to form the final road or floor surface.

In some embodiments, longitudinal and transverse joints are sawn at appropriate locations to control anticipated cracks that will form. In the case of installing static chargers in a new concrete pavement the concrete pavement sawn transverse joint and sawn longitudinal joint are immediately above each side of the modular transmitter assembly. In the case of installing static chargers in an existing concrete pavement the concrete pavement sawn transverse joint and sawn longitudinal joint are immediately above each side of the opening in the existing concrete pavement into which the modular transmitter assembly is installed. The joints can serve as conduits for the wire connections.

An arrangement of the modular transmitter assemblies (precast slabs) can be placed either longitudinally to form a wireless charging corridor or an array to form a complete wireless charging surface charging surface.

In an embodiment, electronics and power systems are embedded in the same pre-manufactured concrete slab.

An embodiment provides a wireless power transfer system contained entirely within a precast concrete slab. The magnetizable concrete mixture for the transmitter includes a pozzolanic binding substance and magnetic particles and a pre-manufactured transmitter coil assembly formed in the magnetizable concrete mixture. The wireless power transmitter coil system is itself completely surrounded by a concrete mix that is suitable for precasting.

As part of the whole system, the electronics and power systems may or may not be formed within the precast concrete slab. The precast concrete slab may be placed on top of a finished floor surface or embedded into the floor. For road applications the precast slabs are preferably embedded within the road structure. Single slabs are suitable for static charging applications. For dynamic wireless charging, several slabs may be placed in a continuous manner along a path or covering a surface allowing power transfer while displacement takes place in any direction.

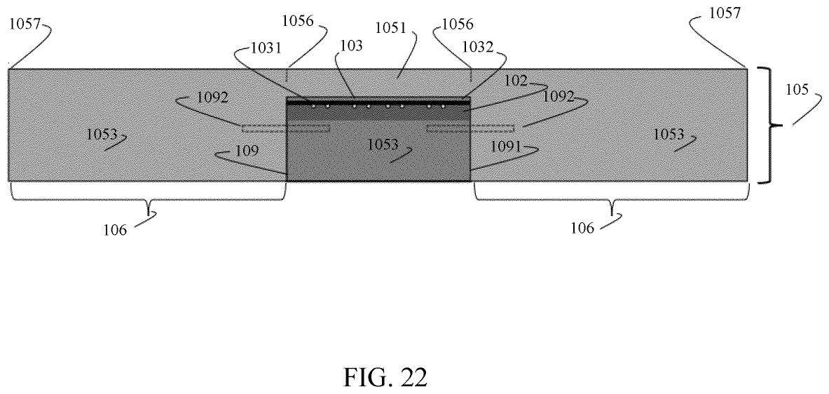

FIG. 22 is a schematic diagram showing a cross section of a concrete pavement containing a pre-manufactured modular wireless power transfer unit in a concrete finished drivable civil structure according to an embodiment of the present disclosure. A concrete pavement may contain a pre-assembled modular transmitter unit 109 installed in the pavement. The pre-assembled modular transmitter unit 109 may include materials in a container 1091 arranged in layers. The sides of the container 1091 may include tie bars 1092 or the tie bars 1092 may extend into the container such that the concrete mixture adjacent to the modular transmitter unit 109 will be bonded to the pre-assembled transmitter unit 109. If the modular transmitter unit is arranged in layers without a container, the tie bars 1092 may be enclosed by the lowest layer of material 1053. Inside the modular transmitter unit 109 the lowest layer contains normal concrete mixture 1053 on which is placed the magnetizable concrete mixture 102, on which is placed the transmitter coil assembly 103. Without a container, the normal concrete mixture 1053 is the lower layer of the transmitter and the magnetizable concrete 102 and the transmitter coil assembly are placed on top. Thickness of the normal concrete mixture 1053 is determined such that the elevation of the transmitter coil assembly 103 will be about 12 cm below the finished elevation of the pavement.

The pre-manufactured transmitter coil assembly 103 is formed in the magnetizable concrete mixture 102. As shown in FIG. 22, the pre-manufactured transmitter coil assembly 103 includes a transmitter coil 1031 and a holder 1032. A part of the transmitter coil 1031 is installed in the holder 1032, and another part of the transmitter coil 1031 is embedded in the magnetizable concrete mixture 102. That is, the transmitter coil 1031 is mounted in the holder 1032 with a desired exposure, typically between 0 to 90 percent of the diameter of the transmitter coil 1031.

Prior to placing concrete pavement, the pre-assembled modular transmitter unit may be installed on the surface of the layer on which the concrete pavement is to be constructed. The thickness of the regular concrete layer 1053 may be adjusted so that the magnetizable concrete mixture 102 and the transmitter coil assembly 103 are at the desired location within the concrete pavement structure.

Two strips of regular concrete 1053 of width 106 may be installed on either side of the pre-assembled modular transmitter unit. The remaining thickness 1051 above the pre-assembled modular transmitter unit 109 may be filled with a fiber-modified concrete or other such modified concrete mixture 1054.

Alternatively, regular concrete 1053 may be cast on either side 106 and up to the thickness of the modular transmitter unit 109. A surface layer of fiber-modified concrete or other such modified concrete mixture 1054 may be cast on top of the regular concrete 1053 and the modular transmitter unit 109 at the same time. Two longitudinal sawn joints 1056 may be made directly above the edge of the modular transmitter unit. A bonding agent 108 may be applied to the top of the first layer 1052, and the top of the pre-assembled transmitter unit 109.

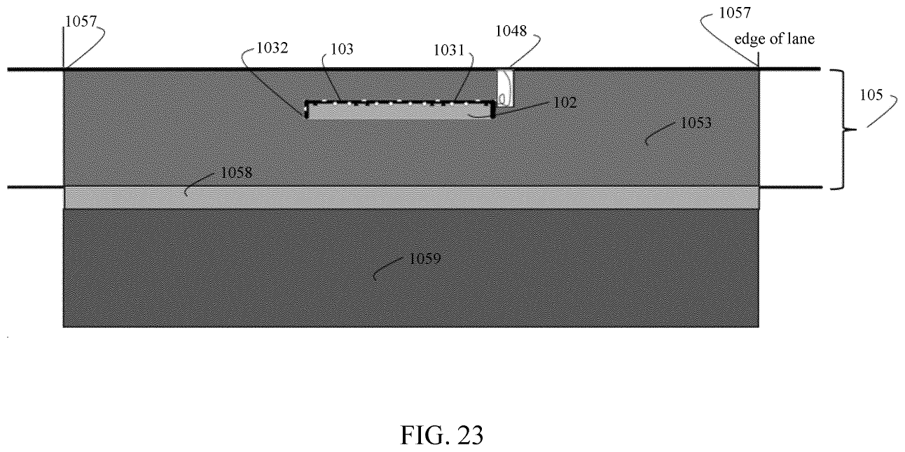

FIG. 23 shows a cross section of an existing concrete pavement rehabilitated with an unbonded concrete overlay containing a pre-assembled modular transmitter unit. The unbonded concrete overlay may be constructed using two layers according to the two pass construction as an alternate embodiment of the transmitter unit. Alternatively, the unbonded concrete overlay may be constructed in one layer with the magnetizable concrete and transmitter coil assembly extruded according to the one pass construction. In addition to the cross section in FIG. 23, the concrete overlay may be bonded to an existing concrete pavement. The concrete overlay may be constructed in two layers according to the two pass construction or in one layer according to one pass construction. Reference number 1058 indicates a bond breaking layer, and reference number 1059 indicates existing concrete pavement.

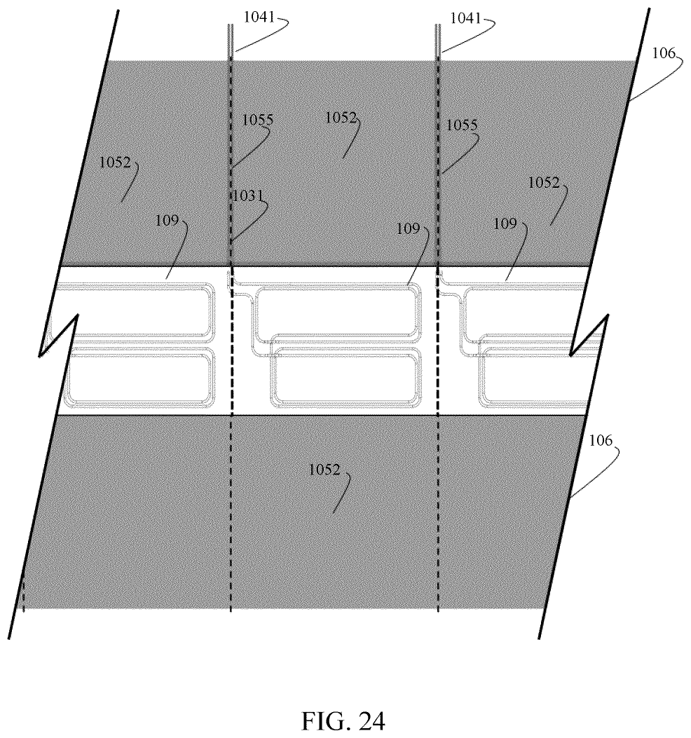

FIG. 24 shows a plan view of concrete pavement containing pre-assembled modular transmitter units after two strips of regular concrete have been cast on either side of the modular transmitter units. The location of transverse joints 1055 is coordinated with the length of the modular transmitter units such that the leads at the end of the transmitter coil align with locations of the transverse joints. At least one power cable 1041 is attached to the transmitter coil and is placed inside the notch sawn for the transverse joint.

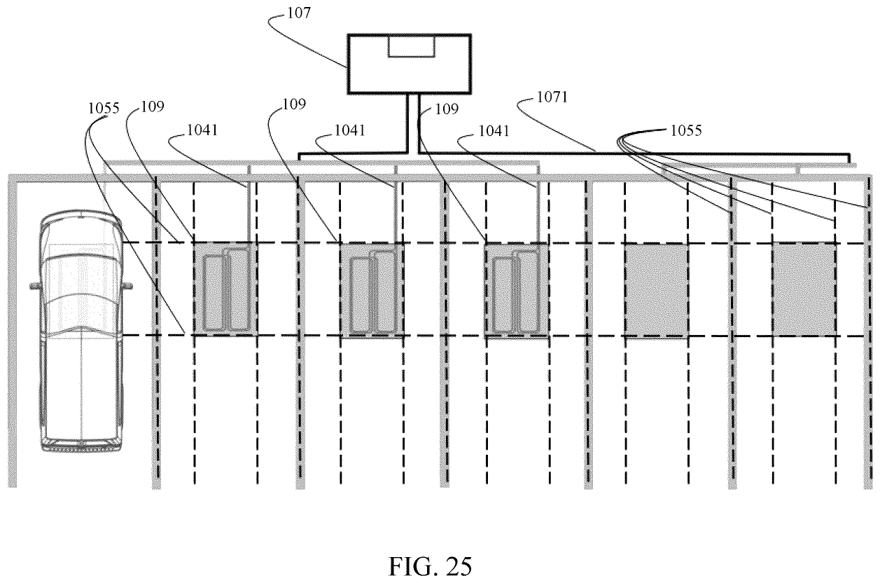

Referring to FIG. 25, static charging is embodied by installing modular transmitter assemblies 109 at a preferential location in each parking space. Power cable(s) 1041 connect from the transmitter assembly to the power cable channel 1071 and onward to the power supply cabinet 107. The height of each modular transmitter assembly 109 is preferentially selected for the transmitter coil assembly to be at a desired elevation below the pavement surface. After the modular transmitter assemblies and power cables are installed each parking space is paved with the desired thickness of concrete so as to encapsulate the transmitter assemblies. Sawn transverse joints 1055 and sawn longitudinal joints are preferentially located along the edges of the transmitter assemblies.

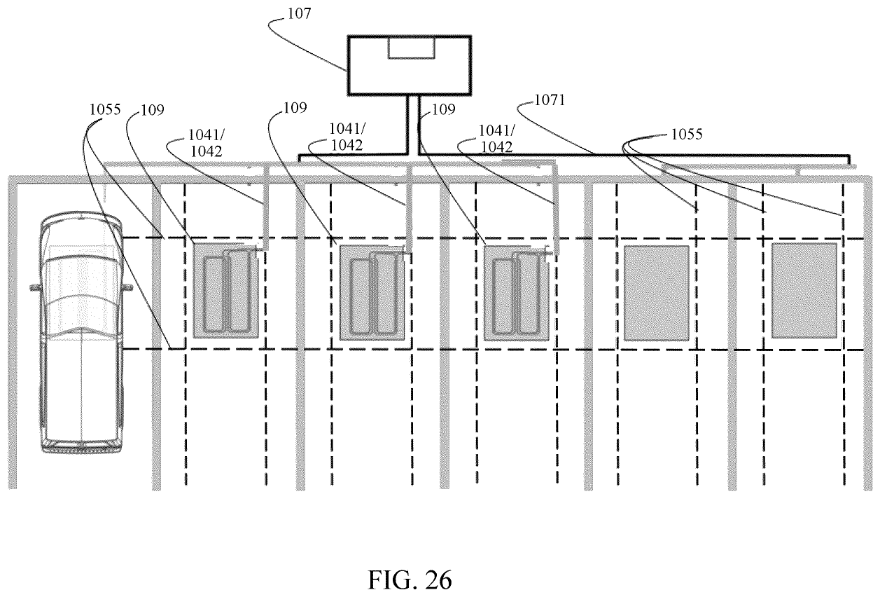

Referring to FIG. 26, static charging is embodied in an existing concrete parking lot by sawing transverse joints 1055 and longitudinal joints 1056. The spacing of the sawn joints is preferentially selected to be larger than the dimensions of the modular transmitter assemblies 109. A section defined by two transverse sawn joints and two longitudinal sawn joints is removed. A modular transmitter assembly 109 is installed in the excavated space. The height of each modular transmitter assembly 109 is preferentially selected for the transmitter coil assembly to be at a desired elevation below the pavement surface. A longitudinal sawcut 1042 for power cable(s) is made into which the transmitter coil power cable(s) 1041 are placed. After the modular transmitter assemblies and power cables are installed each transmitter assembly is encased in modified concrete mixture 1054.

In view of the above, embodiments of the present disclosure relate to a wireless power transfer transmitter system in a concrete pavement and a construction method thereof. The construction method may include a two pass construction method or a one pass construction method. The two construction method includes: forming a channel in a layer of a drivable civil structure; forming a magnetizable asphalt mixture in the channel, the magnetizable concrete mixture including a pozzolanic binding substance and magnetic particles; and placing a pre-manufactured transmitter coil assembly in the magnetizable concrete mixture. The one pass construction method includes extruding magnetizable concrete mixture into the body of a concrete pavement (meanwhile pre-manufactured transmitter coil assembly is also formed). The pre-manufactured transmitter coil assembly includes a transmitter coil, a holder and a transmitter coil connection well. A part of the transmitter coil is installed in the holder, and another part of the transmitter coil is embedded in the magnetizable concrete mixture. Using the technical solutions in the above embodiments, in-place construction of a wireless power transfer transmitter system in a concrete pavement can be realized.

It should be noted that although some sizes or dimensions are labeled in drawings, such sizes or dimensions are only illustrative, and should not be construed as constituting any limitation on the present disclosure. Further, the figures are not necessarily drawn to scale, and for convenience of description, some parts in the figures may be illustrated in an exaggerated manner.

The foregoing descriptions are merely exemplary embodiments of the present disclosure, but the protection scope of the present disclosure is not limited thereto. Any person skilled in the art can easily think of changes or substitutions within the technical scope of the present disclosure, and all the changes or substitutions should be covered by the protection scope of the present disclosure. Therefore, the protection scope of the present disclosure should be defined by the appended claims.

What is claimed is:

1. A construction method of a wireless power transfer transmitter system, comprising:
forming, by a concrete paving machine configured to move in a paving direction for constructing a drivable civil structure, a magnetizable concrete mixture in-place within the drivable civil structure;
wherein the wireless power transfer transmitter system comprises the magnetizable concrete mixture and further comprises a pre-manufactured transmitter coil or a pre-manufactured transmitter coil assembly, the magnetizable concrete mixture comprises a binding material plus one hundred percent or less magnetic particles, the pre-manufactured transmitter coil assembly comprises a transmitter coil and a holder, and a part of the transmitter coil is installed in the holder, and 0 to 90 percent of the transmitter coil is embedded in the magnetizable concrete mixture.

2. The method according to claim 1, wherein forming of the magnetizable concrete mixture comprises:
forming the magnetizable concrete mixture and the pre-manufactured transmitter coil assembly simultaneously in-place within the drivable civil structure using a feeder assembly in the concrete paving machine;
wherein the feeder assembly comprises: a drive mechanism for feeding and positioning the transmitter coil assembly and a feeding hopper from which the magnetizable concrete mixture is introduced, and the feeding hopper is arranged on an underside of the drive mechanism.

3. The method according to claim 2, wherein forming of the magnetizable concrete mixture and the pre-manufactured transmitter coil assembly simultaneously comprises:
introducing the magnetizable concrete mixture into the feeding hopper while feeding the transmitter coil assembly through the drive mechanism to extrude the magnetizable concrete mixture and the transmitter coil assembly simultaneously at an extrusion opening of the feeder assembly;
wherein a feed rate for the drive mechanism to feed the transmitter coil assembly matches a forward speed of the concrete paving machine.

4. The method according to claim 3, wherein the holder is made of a polymer in an inverted U shape of a flat plate or in a shape of a flat plate, the holder is attached to a connection well at an edge of the holder or the holder is attached to a connection well on top of the holder, and the connection well contains ends of the transmitter coil;
wherein during feeding of the transmitter coil assembly, the connection well is caused to move along a slot on a side of the feeder assembly to make the connection well remain outside of the feeder assembly, or the connection well is caused to pass through a protruding portion on a top of the feeder assembly.

5. The method according to claim 4, wherein the holder has a length that is equivalent to required spacing of transverse joints required for concrete pavement in the drivable civil structure and has a connection tab to connect to an adjacent pre-manufactured transmitter coil assembly.

6. The method according to claim 4, wherein the method further comprises:
removing a removable construction top of the connection well and placing a connection well adjustable sleeve in the connection well.

7. The method according to claim 3, further comprising:
while introducing the magnetizable concrete mixture into the feeding hopper and feeding the transmitter coil assembly through the drive mechanism, introducing a non-magnetizable concrete mixture through a bonding window on a top of the feeder assembly to fill shear slots on top of the holder, or introducing concrete grout into a grout hopper above the holder to fill the shear slots on top of the holder.

8. The method according to claim 4, further comprising:
forming a transverse sawcut with a desired depth and width for a power cable which extends from the connection well to an edge of the drivable civil structure,
wherein a transverse sawn joint of the drivable civil structure is coincident with the transverse sawcut for the power cable and the transverse sawn joint is sealed using a sealant.

9. The method according to claim 1, wherein forming of the magnetizable concrete mixture comprises:
forming a channel in a layer of the drivable civil structure;
forming the magnetizable concrete mixture in the channel;
forming the pre-manufactured transmitter coil or the pre-manufactured transmitter coil assembly on the magnetizable concrete mixture.

10. The method according to claim 9, wherein forming the pre-manufactured transmitter coil comprises:
placing a mold that has an engraving with a mirror image of a shape of the transmitter coil in the freshly formed magnetizable concrete mixture and a vibration mechanism, in such a way as to leave a transmitter coil pattern, removing the vibration mechanism and the mold; and placing the pre-manufactured transmitter coil into the transmitter coil pattern left by the mold.

11. The method according to claim 9, wherein forming the pre-manufactured transmitter coil or coil assembly comprises:
placing the pre-manufactured transmitter coil or coil assembly on freshly formed magnetizable concrete mixture; and vibrating the pre-manufactured transmitter coil or coil assembly and the magnetizable concrete mixture using a vibration mechanism.

12. The method according to claim 11, further comprising:
removing the holder.

13. A concrete paving machine configured to move in a paving direction for constructing a drivable civil structure, comprising:
a concrete spreader configured to form a magnetizable concrete mixture in-place within the drivable civil structure;
wherein the wireless power transfer transmitter system comprises the magnetizable concrete mixture and further comprises a pre-manufactured transmitter coil or a pre-manufactured transmitter coil assembly, the magnetizable concrete mixture comprises a binding material plus one hundred percent or less magnetic particles, the pre-manufactured transmitter coil assembly comprises a transmitter coil and a holder, and a part of the transmitter coil is installed in the holder, and 0 to 90 percent of the transmitter coil is embedded in the magnetizable concrete mixture.

14. The concrete paving machine according to claim 13, wherein the concrete spreader comprises: a feeder system configured to form the magnetizable concrete mixture and the pre-manufactured transmitter coil assembly simultaneously in-place within the drivable civil structure;
wherein the feeder assembly comprises: a drive mechanism for feeding and positioning the transmitter coil assembly and a feeding hopper from which the magnetizable concrete mixture is introduced, and the feeding hopper is arranged on an underside of the drive mechanism.

15. The concrete paving machine according to claim 14, wherein the feeder assembly comprises:
a slot provided on a side of the feeder assembly and configured to make a connection well attached to an edge of the holder to move along during feeding of the transmitter coil assembly; or
a protruding portion on a top of the feeder assembly to allow a connection well attached to a top of the holder to pass through.

16. The concrete paving machine according to claim 14, wherein the feeder assembly further comprises:
a bonding window on a top of the feeder assembly to allow a non-magnetizable concrete mixture to be introduced to fill shear slots on top of the holder; or
a grout hopper arranged at a magnetizable concrete mixture inlet of the feeding hooper and configured to introduce a grout hopper above the holder to fill the shear slots on top of the holder;
wherein a bottom lip of the feeder assembly at an extrusion opening is extended further behind the front of a pan in the concrete paving machine.

17. The concrete paving machine according to claim 13, wherein the spreader is configured to:
form a channel in a layer of the drivable civil structure with a blocked section fitted in the screed;
form the magnetizable concrete mixture in the channel by removing the blocked section;
wherein the concrete paving machine further comprises a mechanism configured to 18. A wireless power transfer transmitter system, comprising:
a magnetizable concrete mixture; and
a pre-manufactured transmitter coil or a pre-manufactured transmitter coil assembly;
wherein the wireless power transfer transmitter system comprises the magnetizable concrete mixture and further comprises a pre-manufactured transmitter coil or a pre-manufactured transmitter coil assembly, the magnetizable concrete mixture comprises a binding material plus one hundred percent or less magnetic particles, the pre-manufactured transmitter coil assembly comprises a transmitter coil and a holder, and a part of the transmitter coil is installed in the holder, and 0 to 90 percent of the transmitter coil is embedded in the magnetizable concrete mixture.

19. The wireless power transfer transmitter system according to claim 18, wherein the holder comprises:
shear slots on a top of the holder; or
shear tabs on a bottom of the holder; or
both the shear slots and the shear tabs.

20. The wireless power transfer transmitter system according to claim 19, wherein the holder is made of a polymer in an inverted U shape of a flat plate or in a shape of a flat plate, the holder is attached to a connection well at an edge of the holder or the holder is attached to a connection well at a top of the holder, and the connection well contains ends of the transmitter coil.
